(19) United States
(12) Patent Application Publication
(10) Pub. No.: US 2004/0153641 A1
(43) Pub. Date: Aug. 5, 2004

(54) Computer system manager

(76) Inventor: Gordon Ritchie, London (GB)

Correspondence Address: Testa Hurwitz & Thibeault, Patent Administrator, High Street Tower, 125 High Street, Boston, MA, 02110, US

(21) Appl. No.: 10/471,508

(22) PCT Filed: Mar. 11, 2002
(86) PCT No.: PCT/GB02/01095

(30) Foreign Application Priority Data
Mar. 9, 2001 (GB) 0105793.4

(51) Int. Cl. G06F 9/00

(52) U.S. Cl. 713/2

(57) ABSTRACT

A method of configuring a stand alone or a networked computer allows running two or more copies of an operating system sequentially, and swapping between running of one of the operating system copies to another copy. The method steps comprise: creating an operating system copy at a first address, configured to run from a second address; copying the operating system to a third address; and providing means for a user to inform the computer that one of the addresses is another of the addresses or is to be treated as another of said addresses, in order that a user-selected one of the operating system copies can be run.

This invention relates to an operating system manager. In particular it relates to a means for managing several copies of one or more operating systems on one computer in such a way that:

[1] The user can switch from running one copy of one operating system to running another copy of the same or of a different operating system without having to restart the computer.

[2] The user can run, use, configure, enhance, add programs to, add drivers to, remove drivers from, remove programs from and generally interact with any copy of one operating system without affecting any other copy of this or any other operating system present on the computer.

[3] Subject to hardware and software limitations, the invention can manage any number of copies of operating systems on the same computer.

[4] In the case of Windows™ 9X operating systems, in the preferred embodiment, in addition to the standard ‘my computer icon’ there is provided a further ‘my other computers icon’.

The invention therefore effectively turns one computer into 10 computers in the case where 10 copies (in total) of one or more operating systems are present on one computer.

It is known for one operating system to be able to switch between running one and another of a number of applications without having to terminate either application. This is called ‘Multitasking’.

It is also known for computers to be able to switch between one and another of a number of copies of one or more operating systems by ceasing to run one operating system copy and then ‘switching off’ (soft boot, hard boot or power off) the computer and then restarting the computer and then starting to run the next operating system copy.

It is an aim of the present invention to enable switching between one and another of a number of copies of one or more operating systems without needing to restart the computer, so that what multitasking operating systems are doing with applications, the present invention is almost doing with operating systems themselves.

According to the present invention there is provided A method of configuring a stand alone or a networked computer to run two or more copies of an operating system sequentially, and to swap between running of one of said operating system copies to another copy, the method steps comprising:

[1] creating an operating system copy at a first address, configured to run from a second address;

[2] copying the operating system to a third address; and

[3] providing means for a user to inform the computer that one of said addresses is another of said addresses or is to be treated as another of said addresses, in order that a user-selected one of said operating system copies can be run.

Preferably, the method steps comprise:

[1] Creating an operating system copy at address A, configured to run from address B (where B may or may not be A);

[2] Copying this operating system to address C;

[3] Copying this operating system to addresses D, E, F, G, H, I, J, K, L M, N, O, P etc. if required; and

[4] Providing means for a user to inform the computer that one of said addresses is another of said addresses or is to be treated as another of said addresses.

To run the operating system copy at address A in the case where B=A, simply start the operating system.

To run the operating system copy at address A in the case where B is different from A, inform the PC that address B is now address A and then start the operating system copy.

To run the operating system copy present at any other address, say the copy present at address G for example, inform the PC that address B is now address G and then start the operating system copy.

To swap between running the operating system copy present at address F, for example, and the operating system present at address K, for example, do the following:

[a] End the running of the operating system copy present at address F

[b] Inform the PC that address B is not address F

[c] Inform the PC that address B is address K

[d] Launch the operating system copy at address K

In a preferred embodiment the operating system is Microsoft Windows™ 95 any version or Microsoft Windows™ 98 any version.

In a preferred embodiment the addresses A to P etc. are addresses on a Hard Disk either local to or networked to the PC.

In a preferred embodiment wherein the operating system copy to be run is any version of Microsoft Windows™ 95 or Microsoft Windows™ 98, the operating system copy is launched by running the program WIN.COM in the event that this program is not already running, and by running the command EXIT if WIN.COM is already running. This causes the PC to launch the windows operating system without rebooting the PC

In a preferred embodiment wherein the operating system copy running is a version of Microsoft Windows™ 95 or Microsoft Windows™ 98, the operating system is stopped by ‘dropping to DOS’, which can be achieved by running the program ‘Exit to DOS’ which causes the PC to run Native DOS without rebooting the PC.

In this way the PC can swap between running a first copy of an operating system (preferably any version of Microsoft Windows™ 95 or 98) at one address and running a second copy of an operating system (preferably any version of Microsoft Windows™ 95 or 98 which can be either the same version of the same operating system as the first copy or a different version of the same operating system as the first copy or a different operating system to the first copy) at another address without rebooting the PC.

In a preferred embodiment there is provided a Graphical User Interface to facilitate that swapping between operating systems. In this way one can select one of a number of operating system copies, click on it with the mouse and then the PC will cease to run the current operating system copy and start to run the selected operating system copy.

According to the present invention there is further provided a method of configuring a stand alone or a networked computer to run two or more copies of an operating system sequentially, to swap between running these operating system copies from one copy to another copy, and to swap between running an operating system copy on a hard disk and running an operating system copy on a RAMdisk, said RAMdisk being a portion of the computer's RAM configured as a disk.

Preferably, the method comprises the steps:

[1] creating a copy of the operating system at a first address, configured to run from a second address;

[2] installing a RAMdisk at a third address;

[3] copying the operating system to the RAMdisk; and

[4] configuring the computer so that the second address is or is to be treated as the third address.

Preferably the method includes the step of providing swapping means operable for allowing a user to swap backwards and forwards between running the operating system on the RAMdisk and running the operating system on the hard disk.

In a preferred embodiment, the method step of providing swapping means comprises providing an address changing means.

Preferably, the address changing means comprises means for instructing the computer to change the address of the RAMdisk and the hard disk, which address changing means does not require rebooting of the computer.

An advantage of the present invention is that operating system copies can be changed very quickly (in 10 seconds with Microsoft Windows™ 95 for example) and that various programs that would be terminated if the computer was to be restarted can remain operational and that various files and data that would be lost if a computer was to be restarted can remain in existence. It is therefore easier to transfer data from one operating system copy to another with the present invention wherein the computer does not have to be switched off when swapping between operating system copies.

An advantage in having several copies of one operating system on one computer as opposed to just having one is the same advantage that one gets from having several drawers in a filing cabinet rather that just having one.

A further advantage of embodiments of the invention is the ability to swap from hard disk to RAMdisk operation without rebooting the computer. Typically, a swap can be made from hard disk to RAMdisk operation or vice-versa in about 10 seconds.

The capability to swap between hard disk and RAMdisk at will means that the system on the hard disk can be used to install programs and applications onto the hard disk (where they would normally be expected to reside), but the programs/applications can be run using the operating system on the RAMdisk which provides performance advantages.

In the past, particularly with Microsoft Windows™ operating systems, the one operating system ‘drawer’ tended to get rather overloaded with all sorts of programs and files, to the point where the ‘drawer’ would no longer open or close properly at all, or would open and close very slowly indeed. In fact, in many cases the ‘drawer’ actually fell out of the filing cabinet altogether! In computational terms this wasted the time of the user and either severely impaired or terminated the functionality of the PC. Therefore the user, being aware of this danger, would often elect not to load any new programs into his computer. He therefore had a ‘static’ computer system which was not able to take advantage of any new programs that may have come onto the market. This was especially true with mission critical programs in the case of businesses. Once a system was working and performing its task for the business in an acceptable way, the PC was ordered never to be touched again.

These problems are overcome with the present invention because it provides for the simple management of a multitude of independently controlled operating system copies, allows the user to interact with a second copy of an operating system without affecting the performance of the mission critical first copy.

Embodiments of the invention will now be described with reference to the accompanying drawings in which:

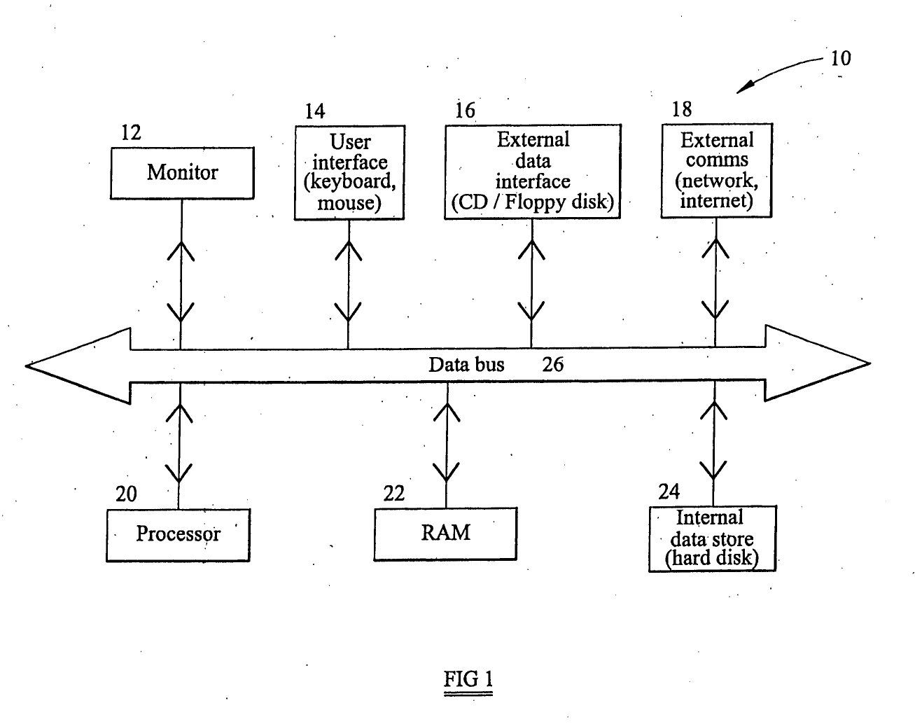

FIG. 1 is a schematic representation showing the principal elements of a known computer;

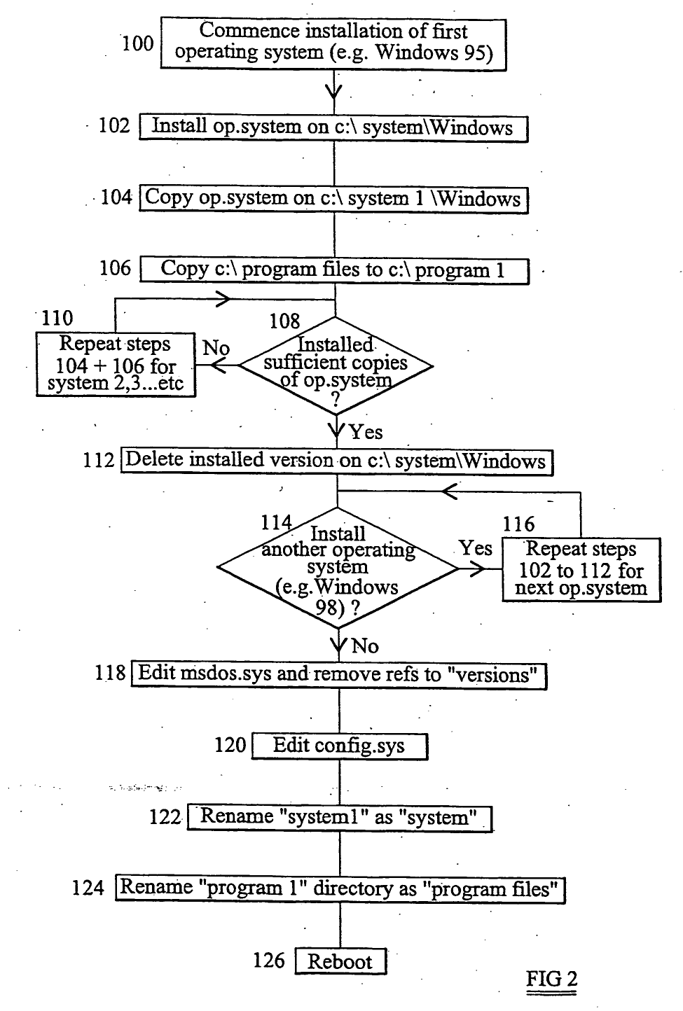

FIG. 2 is a flow chart showing a process for installing operating systems onto a computer in accordance with embodiments of the invention;

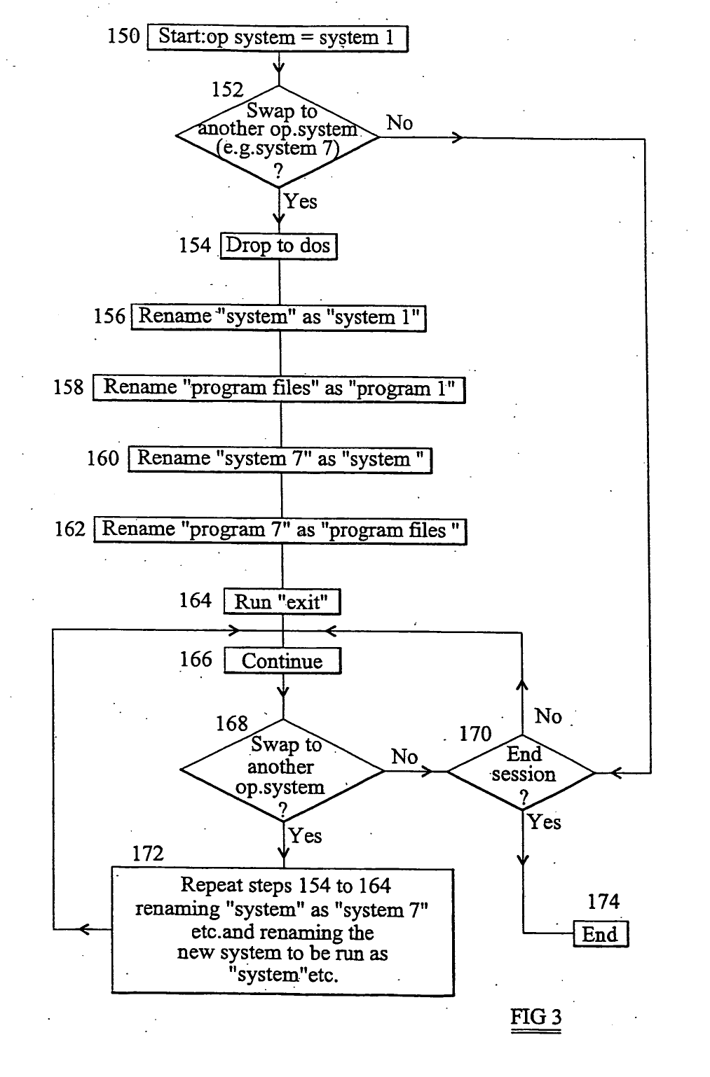

FIG. 3 is a flow chart showing a process in accordance with embodiments of the invention for swapping between operating systems installed on a computer using the process shown in FIG. 2;

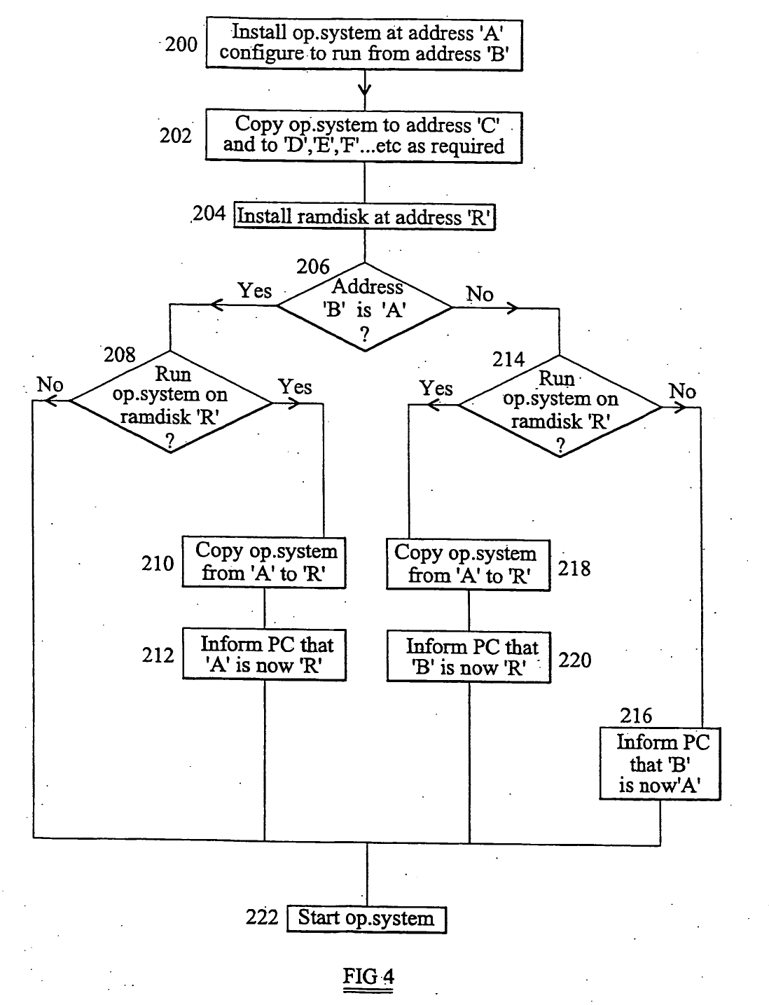

FIG. 4 is a flow chart showing a process for installing operating systems in accordance with embodiments of the invention which includes a RAMdisk; and

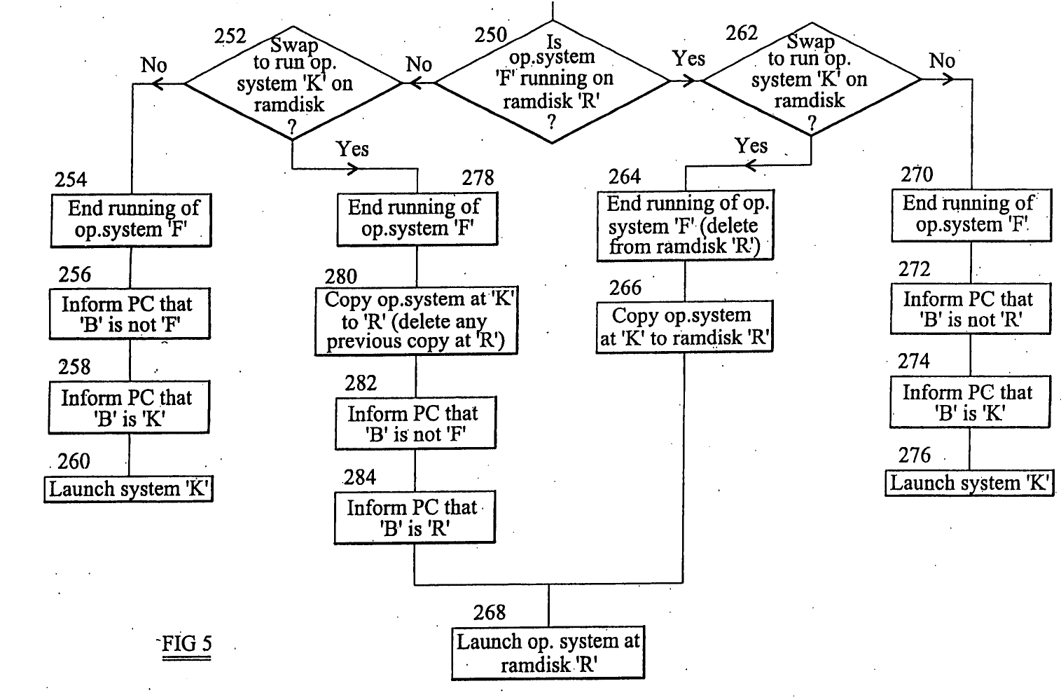

FIG. 5 is a flow chart showing a process in accordance with embodiments of the invention for swapping between operating systems installed on a computer using the process shown in FIG. 4.

As shown in FIG. 1, a computer 10, typically a PC, comprises: a monitor 12; a user interface 14 which may include a keyboard and a mouse; an external data interface 16 for reading data stored in external memory media such as a CD or floppy disk; an external communications interface 18 for providing communication with other computers in a network or via the internet; a processor 20; a RAM 22; an internal data store 24, such as a hard disk; and a data bus 26 for providing communication between the components. In many computers data bus 26 may comprise one or more communication buses dedicated to communications between one component and another (for example between the processor and RAM).

Technical Specification for Hyperos 2000

This section describes how to make one computer into 10 computers' using a 10 system implementation of the system manager which is called herein Hyperos 2000 running both Windows™ 95 and Windows™ 98. One can then run or use any one of the 10 operating system copies and one can swap from one copy to another without having to reboot the machine.

Referring to FIG. 2, the process for installing the operating systems commences at step 100 and proceeds as follows.

[1] At step 102, install Windows™ 95 in the directory c:\system\windows.

[2] The directory ‘Program Files’ will be placed on the root of the C: drive. It is possible to change the path of this directory using a Windows™ registry editor, but if you do then some Windows™ applications will not run properly so it is not advisable.

[3] Procure a long file name preserving hidden system and read only file copying program such as LCOPY.EXE by ‘Odi’ Ortwin Glueck, which is available free on the internet (just search under LCOPY.EXE and download it from an appropriate site http://odi.webjump.com or www.simtel.net normally have it). Whilst you are there get LREN.EXE which renames files with long file names in DOS and LDIR.EXE which lists files showing their long file names in DOS as well.

[4] At step 104, copy the operating system from c:\system\windows to c:\system1\windows using LCOPY.EXE or the likes:

LCOPY c:\system\windows\* c:\system1\windows /a /s /b

Or another appropriate command line should do it.

[5] At step 106, copy c:\program files to c:\program1 using LCOPY.EXE or the likes.

[6] Make further copies of the operating system and the program files to as many other systems and directories as desired, let us say to from c:\windows\system2 to c:\windows\system5, and c:\program2 to c:\program5 respectively (steps 108 and 110).

[7] At step 112, delete the installed version in c:\windows\system and in c:\program files.

At step 114, if it is not required to install another operating system, proceed immediately to step 118. However, in the present example it is intended to install Windows 98 at step 116 using the following procedure (which is essentially a repeat for Windows 98 of the above procedure for Windows 95).

[8] Install Windows 98 in the directory c:\system\windows

[9] Again the directory ‘Program Files’ will be placed on the root of the C: drive. Again it is possible to change the path of this directory using a Windows™ registry editor, but if you do then some Windows™ applications will not run properly so it is not advisable.

[10] Copy the operating system from c:\system\windows to c:\system6\windows using LCOPY.EXE or the likes.

[11] Copy c:\program files to c:\program6 using LCOPY.EXE or the likes.

[12] Make further copies of the operating system and the program files to as many other systems and directories as desired, let us say to from c:\windows\system6 to c:\windows\system10, and c:\program6 to c:\program10 respectively.

[13] Delete c:\windows\system and Delete c:\program files by running Smartdrv.exe and using Deltree.exe or the likes.

Once all the required operating system copies have been made, proceed to step 118.

[14] At step 118, edit msdos.sys to have:

SystemReg=0

Logo=0

and remove any reference to versions of Windows™

[15] At step 120, edit config.sys to have the lines:

Device=c:\sys\himem.sys

Device=c:\sys\ifshlp.sys

Device=c:\sys\dblbuff.sys

Device=c:\sys\setver.exe

Making sure that you have placed the relevant files in the c:\sys directory.

[16] At step 122, rename say the ‘system1’ directory to be the ‘system’ directory using any DOS directory renaming means, preferably using the DOS REN command from the root directory:

REN system1 system

[17] At step 124, rename the ‘program1’ directory to be ‘program files’ directory using LREN from the root directory or using another Long File Name DOS renaming means:

LREN program1 “program files”

[18] Finally, at step 126, reboot.

[19] The PC will run the operating system copy designated as ‘system’. This is the copy that was present at c:\system1\windows before renaming. Referring to FIG. 3, the ‘system’ copy is ‘system 1’ at step 150. At step 152, if the decision is made not to swap to another system proceed directly to step 170. If the decision is to swap to run another operating system copy, say the one present at c:\system7\windows, the following steps are made:

[a] At step 154, drop to DOS.

[b] At step 156, rename the system directory back to system1.

[c] At step 158, rename the ‘Program Files’ directory back to program1.

[d] At step 160 rename the directory system7 to be system.

[e] At step 162, rename, using LREN or the likes, the program7 directory to be ‘Program Files’.

[f] At step 164 run the EXIT command.

This will launch Windows™ 98 from the system7 directory without rebooting the PC.

At step 166, continue use of the operating system. At step 168 a decision is made whether or not to swap to another operating system. If the answer is NO, proceed to step 170.

At step 170, proceed to step 174, if the decision is to end the session. Otherwise step back to step 166 to continue the session.

If the decision at step 168 is to swap to another operating system, proceed to step 172, where the procedure for swapping systems described above in steps 154 to 164 is followed for replacing ‘system 7’ with the new system to be run.

RAMdisk and Hyperos 2000 Combination

It is possible to use the present invention in conjunction with a hyperdrive, a hyperdrive being a portion of a computer's RAM configured as a disk or RAMdisk and from which an operating system may be run, as disclosed in UK Patent Application No. 0100434.0.

The most general method of configuring a stand alone or a networked PC to run a large operating system from and in RAM, where A, B and C are local addresses to the PC, is as follows:

[1] Create a copy of the operating system at address A, configured to run from address B (where B may or may not be A);

[2] Install a RAMdisk at address C (where C may or may not be A or B);

[3] Copy the operating system copy to the RAMdisk;

[4] If necessary, reconfigure or readdress the software or hardware or firmware or BIOS or other component or components of the PC so that Address B from which the operating system is configured to run (which may or may not be Address A, where the operating system copy was created), is treated as, or actually becomes Address C, where the RAMdisk is installed.

Note that there is no need to further reconfigure the operating system copy to run from Address C, this flexibility is already provided by address B. Also, you cannot copy after the readdressing because A might be C.

[5] Start the operating system on the RAMdisk

In a preferred embodiment Address A is an address on a hard disk.

In another embodiment, the operating system can be run from the hard disk drive or from the RAMdisk and the user may swap between the two without the need to reboot the computer

An operating system copy is created at a first predetermined drive code (address) and is configured to run from a second predetermined drive code (which may or may not be the first predetermined drive code). The operating system is then copied to a hard disk or hard disk partition having a third predetermined drive code and to the RAMdisk having a fourth predetermined drive code.

Using the DOS “subst” command or similar means, if the computer is told that the second predetermined drive code is in fact the third predetermined drive code, then it will run the operating system from the hard disk. If, on the other hand, it is told that the second predetermined drive code is in fact the fourth predetermined drive code, then it will run the operating system from the RAMdisk.

In this way, by sequentially telling the computer that the second predetermined drive code is in fact one or the other of the third or the fourth predetermined drive codes, the computer can be made to run the operating system from the hard disk or RAMdisk at will.

For technical reasons it has been found preferable to leave the operating system copy created on the hard disk with the first predetermined drive code but configured to run from a second predetermined drive code (that may or may not be the first predetermined drive code) in place. This place is termed the anchor partition if it is a partition.

The method works as follows, with reference to FIG. 4:

[1] At step 200, install the operating system at Address A, configured to run from Address B (where B may or may not be A);

[2] At step 202, copy this operating system to address C, and

[3] Copy this operating system to addresses D, E, F, G, H, I, J, K, L M, N, O, P etc. if required;

[4] At step 204 install a Ramdisk at address R;

[5] If at step 206 it is determined that address B is address A, and at step 208 it is determined to run the operating system copy at address A on the hard disk, proceed to step 222 and simply start the operating system;

[5a] If at step 208 it is determined to run the operating system copy at address A on the RAMdisk, at step 210 copy the operating system from A to R, at step 212 inform the PC that address A is now Address R, and at step 222 start the operating system copy at address R;

[6] In the case where at step 206 it is determined that B is different from A, and at step 214 it is decided to run the operating system copy at address A on the hard disk, at step 216 inform the PC that address B is now address A and then, at step 222, start the operating system copy at address A;

[6a] Where it is decided at step 214 to run the operating system copy at address A on the RAMdisk, at step 218 copy the operating system from A to R, at step 220 inform the PC that address B is now address R and then, at step 222, start the operating system copy at address R;

[7] To run the operating system copy present at any other address, say the copy present at address G for example, on the hard disk, inform the PC that address B is now address G and then start the operating system copy at address G;

[7a] To run the operating system copy present at any other address, say the copy present at address G for example, on the RAMdisk, copy the operating system from address G to address R, inform the PC that address B is now address R and then start the operating system copy at address R.

Referring to FIG. 5, the method steps for swapping between running an operating system copy at, for example, address F (system F) and the operating system copy at, for example, address K (system K), includes determining at step 250 whether system F is running on the RAMdisk ‘R’. If not, at step 252 a determination is made whether to run system K on the hard disk or on the RAMdisk.

[8] To swap between running operating system F on the hard disk F and operating system K on the hard disk, do the following:

[a] At step 254, end the running of the operating system F,

[b] At step 256, inform the PC that address B is not address F,

[c] At step 258, inform the PC that address B is address K,

[d] At step 260, launch the operating system copy at address K;

If at step 250 it is determined that system F is running on the RAMdisk, then at step 262 a determination is made whether to run system K on the hard disk or on the RAMdisk.

[8a] To swap between running system F on the Ramdisk and system K on the RAMdisk, do the following:

[a] At step 264, end the running of the operating system copy present on the Ramdisk (which was copied from address F),

[b] At step 266, copy the operating system from address K to address R (having deleted the previous system at address R at step 264),

[c] At step 268, launch the operating system copy at address R.

[8b] If at step 262 it is decided to run system K on the hard disk, then to swap between running system F on the Ramdisk and running system K on the hard disk, do the following:

[a] At step 270, end the running of the operating system copy present on the Ramdisk (which was copied from address F),

[b] At step 272, inform the PC that address B is not address R,

[c] At step 274, inform the PC that address B is address K,

[d] At step 276, launch the operating system copy at address K.

[8b] Finally, from the determinations at steps 250 and 252 to swap between running system F on the hard disk and running system K on the RAMdisk, do the following:

[a] At step 278, end the running of the operating system copy at address F,

[b] At step 280, copy the operating system from address K to address R (deleting any previous system at address R),

[b] At step 282, inform the PC that address B is not address F,

[c] At step 284, inform the PC that address B is address R,

[d] At step 268, launch the operating system copy at address R.

In the preferred embodiment the operating system is Microsoft Windows™ 95 any version or Microsoft Windows™ 98 any version.

In the preferred embodiment the addresses A to P etc. are addresses on a Hard Disk either local to or networked to the PC.

In the preferred embodiment wherein the operating system copy to be run is any version of Microsoft Windows™ 95 or Microsoft Windows™ 98. The operating system copy is launched by running the program WIN.COM in the event that this program is not already running, and by running the command EXIT if WIN.COM is already running. This causes the PC to launch the windows operating system without rebooting the PC

In the preferred embodiment wherein the operating system copy running is a version of Microsoft Windows™ 95 or Microsoft Windows™ 98, the operating system is stopped by ‘dropping to DOS’, which can be achieved by running the program ‘Exit to DOS’ which causes the PC to run Native DOS without rebooting the PC.

In this way the PC can swap between running a first copy of an operating system (preferably any version of Microsoft Windows™ 95 or 98) at one address and running a second copy of an operating system (preferably any version of Microsoft Windows™ 95 or 98 which can be either the same version of the same operating system as the first copy or a different version of the same operating system as the first copy or a different operating system to the first copy) at another address without rebooting the PC. And the PC can swap between running any of the operating systems on the hard disk and running them on the RAMdisk without rebooting.

In the preferred embodiment there is provided a Graphical User Interface to facilitate that swapping between operating systems and swapping between hard disk and RAMdisk operation. In this way one can select one of a number of operating system copies, click on it with the mouse and then the PC will cease to run the current operating system copy either on the hard disk or the RAMdisk and start to run the selected operating system copy on the selected disk (hard or RAM).

Technical Specification of RAMdisk and Hyperos 2000 Combination Invention Using Directories

This section describes how to ‘make one computer into 10 computers’ using a 10 system implementation of Hyperos 2000 running both Windows™ 95 and Windows™ 98. And it describes how to run each of these 10 systems either in RAM or on the Hard Disk. One can then run or use any one of the 10 operating system copies and one can swap from one copy to another without having to reboot the machine. One can also swap from hard disk to RAMdisk operation without rebooting the machine.

[1] Install Windows™ 95 in the directory c:\system\windows.

[2] The directory ‘Program Files’ will be placed on the root of the C: drive. It is possible to change the path of this directory using a Windows™ registry editor, but if you do then some Windows™ applications will not run properly so it is not advisable.

[3] Procure a long file name preserving hidden system and read only file copying program such as LCOPY.EXE by ‘Odi’ Ortwin Glueck, which is available free on the internet (just search under LCOPY.EXE and download it from an appropriate site http://odi.webjump.com or www.simtel.net normally have it). Whilst you are there get LREN.EXE which renames files with long file names in DOS and LDIR.EXE which lists files showing their long file names in DOS as well.

[4] Copy the operating system from c:\system\windows to c:\system1\windows using LCOPY.EXE or the likes:

LCOPY c:\system\windows\* c:\system1\windows /a /s /b

Or another appropriate command line should do it;

[5] Copy c:\program files to c:\program1 using LCOPY.EXE or the likes.

[6] Make further copies of the operating system and the program files to as many other systems and directories as desired, let us say to from c:\windows\system2 to c:\windows\system5, and c:\program2 to c:\program5 respectively.

[7] Delete the installed version in c:\windows\system and in c:\program files (Preferably run Smartdrv.exe and then use Deltree.exe).

[8] Install Windows 98 in the directory c:\system\windows.

[9] Again the directory ‘Program Files’ will be placed on the root of the C: drive. Again it is possible to change the path of this directory using a Windows™ registry editor, but if you do then some Windows™ applications will not run properly so it is not advisable.

[10] Copy the operating system from c:\system\windows to c:\system6\windows using LCOPY.EXE or the likes.

[11 Copy c:\program files to c:\program6 using LCOPY.EXE or the likes.

[12] Make further copies of the operating system and the program files to as many other systems and directories as desired, let us say to from c:\windows\system6 to c:\windows\system10, and c:\program6 to c:\program10 respectively.

[13] Delete c:\windows\system and Delete c:\program files.

[14] Edit msdos.sys to have:

SystemReg=0

Logo=0

and remove any reference to versions of Windows™.

[15] Edit config.sys to have the lines:

Device=c:\sys\himem.sys

Device=c:\sys\ifshlp.sys

Device=c:\sys\dblbuff.sys

Device=c:\sys\setver.exe

Making sure that you have placed the relevant files in the c:\sys directory.

[16] Rename say the ‘system1’ directory to be the ‘system’ directory using the DOS REN command from the root directory:

REN system1 system

[17] Rename the ‘program1’ directory to be ‘program files’ directory using LREN from the root directory:

LREN program1 “program files”

[18] Reboot.

[19] The PC will run the operating system copy present at c:\system1\windows on the hard disk.

[20] Create a RAMdisk at address R using xmsdsk.exe as described in UK Patent Application No. 0100434.0.

[21] To swap to running another operating system copy on the hard disk, say the one present at c:\system7\windows, the following steps are made:

[a] Drop to DOS

[b] Rename the system directory back to system1

[c] Rename, using LREN, the ‘Program Files’ directory back to program1

[d] Rename the directory system7 to be system

[e] Rename, using LREN, the program7 directory to be ‘Program Files’

[f] Run the EXIT command.

This will launch Windows™ 98 from the system7 directory without rebooting the PC.

[22] To swap to running say the operating system copy present in the system4 directory on the RAMdisk the following steps are made:

[a] Drop to DOS

[b] Rename the system directory back to the previous system

[c] Rename, using LREN, the ‘Program Files’ directory back the previous program files directory

[d] Rename the directory system4 to be system

[e] Rename, using LREN, the program4 directory to be ‘Program Files’

[f] Using LCOPY.EXE with the appropriate switches and command line copy the system directory and the ‘program files’ directory from the hard disk to the RAMdisk at address R. Delete all previous systems and program files at address R. You will end up with r:\system\windows and r:\program files.

[g] Run the EXIT command. This will launch the operating system copy on the RAMdisk at R without rebooting the PC.

RAMdisk and Hyperos 2000 Combination Invention Called Hyperos 2001 Multi GUI Boot Operating System Manager Using Partitions

This is our most powerful operating system. It enables the user to have any number, but preferably up to 10 copies of Windows™ 95 or Windows™ 98 or a mixture of the two on one computer. One can then run or use any ONE of these copies and one can swap from one copy to another without having to reboot the machine. In fact one can swap to running any of the 10 systems either on the hard disk mirror or on the Hyperdrive without having to reboot the machine. One simply reboots Windows™, the GUI interface. Hence we have called it a multi GUI boot operating system manager.

The 10 System version works as follows:

[1] Partition your hard disk to have the boot partition (say C:\) which is preferably FAT32 and reasonably large, preferably 2 GB or more. Then a further 10 system partitions, D: to M: which may are FAT16 in the preferred embodiment, because the preferred fast copying means does not work with FAT32 partitions. So these will be up to 2 GB in size, preferably 2 GB. Then make a 12th partition, N: which we will call the ‘Anchor’ Partition.

[2] Clean boot and Install one copy of Windows™ 95 on to the Anchor Partition (N:).

[3] At the first reboot in the Windows™ installation procedure, reinsert the windows 95 start up disk and return to DOS. Then replace the config.sys file that Windows™ has created with the following file:

Config.sys

Device=c:\sys\himem.sys

Device=c:\sys\ifshlp.sys

Device=c:\sys\dblbuff.sys

Device=c:\sys\setver.exe

When the installation is completed, then load all motherboard drivers, and load all operating system patches and supplements etc.

[4] Image the system to an image file on the C: drive say: w95.img

[5] Wipe the N: partition.

[6] Clean boot and Install one copy of Windows™ 98 on to the Anchor Partition (N:).

[7] At the first reboot in the windows installation procedure, reinsert the windows 98 start up disk and return to DOS. Then replace the config.sys file that windows has created with the file above. Then load all motherboard drivers and load all operating system patches and supplements etc.

[8] Copy the image file w95.img from the Boot drive to the D, E, F, G, H drives. And copy the Windows™ 98 system from the N drive to the I, J, K, L, M drives. And make an image of the Windows™ 98 system called say w98.img

[9] Now you have 10 operating system copies all of which are set to run on the N: drive. And you have the copy of the Windows™ 98 operating system on the N: drive as well.

[10 ] You can now choose to run any ONE of these 11 systems by either not making any drive substitution in the case of the N: drive or by substituting N: to be either D, E, F, G, H, I, J, K, L or M in the cases of the other 10 drives. These substitutions can be made without rebooting the machine (except in the case of returning to the Anchor drive). For example if one is running on the N: drive and one wishes to run on say the F: drive. This is the preferred process to follow:

| | |
|---|---|
| [a] | Drop to DOS |
| [b] | Run the command c:\sys\subst n: f:\ |
| | This makes the F: drive into the N: drive |
| [c] | Run the command Exit |

This will restart the version of Windows™ on the F: drive. If one now wishes to run the system on the K drive the preferred process is:

| | |
|---|---|
| [a] | Drop to DOS |
| [b] | Run the command c:\sys\subst n: /d |
| | This terminates any previous substitution |
| [c] | Run the command c:\sys\subst n: k:\ |
| | This makes the K: drive into the N: drive |
| [d] | Run the command Exit |

This will restart the version of Windows on the K: drive.

[11] To run any of these versions of Windows™, (say the one on the G: drive) on the hyperdrive, this is the preferred process to follow:

| [a] | Drop to DOS |
|---|---|
| [b] | create a sufficiently large Ramdisk as drive R: |
| | using say: c:\hyper\xmsdsk |
| 500000 R: /c1/t/y | |
| [c] | Copy the G: drive to the R: drive using say: |
| | c:\hyper\hdcp /i-/t-/y G: R: |
| [d] | Run the command c:\sys\subst n: /d |
| | This terminates any previous substitution |
| [e] | Run the command c:\sys\subst n: r:\ |
| | This makes the R: drive into the N: drive |
| [f] | Run the command Exit |

This will restart the version of Windows that was on the G: drive on the Hyperdrive. Incidentally if the Hyperdrive already exists, then step [b] is obviously unnecessary.

In this way one has complete freedom to start any of the 10 versions of either Windows™ 95 or Windows™ 98 on either the Hard Disk Mirror, or the Hyperdrive without rebooting the computer.

What one then has is a filing cabinet with more than one drawer in it. Rather than overloading one particular copy of windows with a huge number of programs and essentially stuffing everything into one drawer in ones filing cabinet, which slows down information processing in the real office and likewise slows down information processing in your computer, your electronic office. One splits programs up between the various different systems, and all of the systems then perform faster, and are less likely to crash.

The reader may well experience being in the position of trying to decide whether or not to install a new program on to his or her computer. He or she will know that this program may cause Windows™ to crash and may not be easy to uninstall. So the decision may be made not to install it, or the installation may occur and the computer may be rendered inoperative if there is a problem. This dilemma is solved by having several copies of Windows™ on one computer. You have your important mission critical system, which is never changed. And you try out new programs on a less important system to see how they go. If they are no good you can wipe out the whole system and replace it with either a virgin image file of Windows 95 or a virgin image file of Windows™ 98 or one of your other systems. You might choose to have an office system, and internet system, an entertainment system, and special graphics system and special scientific system etc. It is recommended that programs are installed on the respective Hard disk mirrors and run on the Hyperdrive.

The purpose of the Anchor partition is to provide a real Windows™ Registry at the correct address, the N: drive, for Windows™ to look at (fairly superficially) during boot up of the computer. Without the Anchor partition, the various versions of Windows™ get confused and will not boot up. This is not so big a problem if all versions of Windows™ are 95 or all of them are 98. But it gives more flexibility in any event.

1. A method of configuring a stand alone or a networked computer to run two or more copies of an operating system sequentially, and to swap between running of one of said operating system copies to another copy, the method steps comprising:
[1] creating an operating system copy at a first address, configured to run from a second address;
[2] copying the operating system to a third address; and
[3] providing means for a user to inform the computer that one of said addresses is another of said addresses or is to be treated as another of said addresses, in order that a user-selected one of said operating system copies can be run.

2. The method of claim 1, wherein step [3] comprises providing means for a user to inform the computer that one of said addresses is another of said addresses or is to be treated as another of said addresses, which means does not require re-booting of the computer.

3. The method of claim 1 wherein step [3] comprises providing means for a user to inform the computer that one of said addresses is another of said addresses or is to be treated as another of said addresses, which means does not require multibooting of the computer.

4. The method of any one of claims 1 to 3, wherein the second address is the first address.

5. The method of any one of claims 1 to 3, wherein step [2] further includes copying the operating system to one or more further addresses as required.

6. The method of any preceding claim wherein the operating system is Microsoft Windows™ 95 any version, or Microsoft Windows™ 98 any version.

7. The method of any preceding claim wherein the addresses are addresses on a hard disk either local to or networked to the computer.

8. The method of any preceding claim, including a further step of providing swapping means for facilitating swapping by a user between running an operating system copy at one of said addresses, and running another operating system copy at another one of said addresses.

9. The method claim 8, wherein the swapping means is a Graphical User Interface, whereby, when a first operating system copy is being run, the user can select another of said operating system copies so that the computer will cease to run the first operating system copy and start to run the selected operating system copy.

10. The method of claim 8, wherein the other operating system copy to be run contains a launching program for launching an operating system copy, said swapping means comprising:
instructions for causing the computer to run the launching program in the event that the launching program is not already running; or
instructions for the computer to execute a predetermined command, if the launching program is already running,
thereby causing the computer to launch the operating system copy without rebooting the computer.

11. The method of claim 10, wherein the other operating system copy is any version of Microsoft Windows™ 95 or Microsoft Windows™ 98 wherein the launching program is WIN.COM.

12. The method of claim 6, wherein the first operating system copy running is a version of Microsoft Windows™ 95 or Microsoft Windows™ 98 including a program ‘Exit to DOS’ which causes the computer to run Native DOS without rebooting, the swapping means comprising stopping the first operating system copy by running the program ‘Exit to DOS’.

13. A method of configuring a stand alone or a networked computer to run two or more copies of an operating system sequentially, to swap between running these operating system copies from one copy to another copy, and to swap between running an operating system copy on a hard disk and running an operating system copy on a RAMdisk, said RAMdisk being a portion of the computer's RAM configured as a disk.

14. The method of claim 13, comprising the steps:
[1] creating a copy of the operating system at a first address, configured to run from a second address;
[2] installing a RAMdisk at a third address;
[3] copying the operating system to the RAMdisk; and
[4] configuring the computer so that the second address is or is to be treated as the third address.

15. The method of claim 13 or claim 14 including the step of providing swapping means operable for allowing a user to swap backwards and forwards between running the operating system on the RAMdisk and running the operating system on the hard disk.

16. The method of claim 15 wherein the step of providing swapping means comprises providing an address changing means.

17. The method of claim 16 wherein the address changing means comprises means for instructing the computer to change the address of the RAMdisk and the hard disk, which address changing means does not require rebooting of the computer.

18. The method of claim 16 wherein the address changing means comprises means for instructing the computer to change the address of the RAMdisk and the hard disk, which address changing means does not require multibooting of the computer.

19. A software carrier medium comprising computer readable code for a computer processor to implement the method steps in accordance with any preceding claim.

20. A computer configured in accordance with the method of any one of claims 1 to 18 to run two or more copies of an operating system sequentially and to swap between running said operating system copies from one copy to another copy.
